(19) United States
(12) Patent Application Publication
(10) Pub. No.: US 2007/0050096 A1
(43) Pub. Date: Mar. 1, 2007

(54) Programmable actuator controller for power positioning seat or leg support of a wheelchair

(75) Inventors: John Mattes, Columbia Station, OH (US); Darryl Peters, Elyria, OH (US); Ricky J. McCullar, Olmsted Township, OH (US); Gary E. Chopcinski, North Ridgeville, OH (US)

Correspondence Address: CALFEE HALTER & GRISWOLD, LLP, 800 SUPERIOR AVENUE, SUITE 1400, CLEVELAND, OH, 44114, US

(73) Assignee: Invacare Corporation

(21) Appl. No.: 11/513,740

(22) Filed: Aug. 31, 2006

Related U.S. Application Data
(60) Provisional application No. 60/727,005, filed on Oct. 15, 2005.
(60) Provisional application No. 60/712,987, filed on Aug. 31, 2005.

(51) Int. Cl. G05D 1/00

(52) U.S. Cl. 701/1

(57) ABSTRACT

An actuator controller for operating a selected one of a plurality of known seat and leg support position actuators of a wheelchair comprises: a digital controller; and an actuator driver circuit coupled to the digital controller and capable of driving any one of the plurality of known seat and leg support position actuators, the digital controller programmable with data representative of a selected one of the plurality of known seat and leg support position actuators and operational parameters thereof, and operative to control the actuator driver circuit to drive the selected one of the plurality of known seat and leg support position actuators in accordance with the parameter data.

This application claims the benefit of the filing dates of the U.S. Provisional Application No. 60/727,005, filed Oct. 15, 2005, and U.S. Provisional Application No. 60/712,987, filed Aug. 31, 2005.

### BACKGROUND

The present invention is directed to the field of power driven wheelchairs, in general, and more particularly, to a programmable actuator controller for power positioning a seat or leg support of a wheelchair.

Power driven wheelchairs which may be of the type manufactured by Invacare Corporation of Elyria, Ohio, for example, are generally controlled by an electronic control system. An exemplary control system for power or motor driven wheelchairs is disclosed in U.S. Pat. No. 6,819,981, entitled “Method and Apparatus for Setting Speed/Response Performance Parameters of a Power Driven Wheelchair”, issued Nov. 16, 2004, and assigned to the same assignee as the instant application, which patent being incorporated by reference herein in its entirety.

In current wheelchair designs, power seat and leg support positioning are performed open-loop. Generally, an electrical actuator is coupled to the seat or leg support portion in a mechanical arrangement to permit positioning of the seat or leg support portion upon movement of the actuator. Typical electrical actuators may be of the type manufactured by LINAK® bearing model numbers LA30 and LA31, for example. In some wheelchair models, there may be more than one actuator for positioning the different portions of the seat and/or leg support. For example, a recline actuator may be coupled mechanically to the back of the seat; and tilt and seat elevation actuators may be mechanically coupled to the seat bottom. Each actuator is coupled through a user-operated switch to a power source.

When the user desires to power position the seat or leg support, he or she operates the switch to apply power to the proper actuator until the seat or leg support is moved to a desired position. Some wheelchair models may also include sensors and switches along the movement path of the seat and leg support portions to ensure against movement beyond what is safe for the user and wheelchair.

A drawback of the current wheelchair designs is that the electrical actuators of the power seat and leg support positioning can not be individually controlled by a desired position set point. For example, the electrical actuators can not be set to desired predetermined seat or leg support position settings in a closed-loop operation by the wheelchair control system. One aspect of applicants' general concept is intended to overcome this drawback through use of a set point driven actuator controller. In addition, it is desirable to have an electronic unit that is common to a plurality of known power seat and leg support position actuators of the wheelchair and programmable to the particular position actuator being controlled thereby.

### SUMMARY OF THE INVENTION

In accordance with one aspect of the present invention, an actuator controller for operating a selected one of a plurality of known seat and leg support position actuators of a wheelchair comprises: a digital controller; and an actuator driver circuit coupled to the digital controller and capable of driving any one of the plurality of known seat and leg support position actuators, the digital controller programmable with data representative of a selected one of the plurality of known seat and leg support position actuators and operational parameters thereof, and operative to control the actuator driver circuit to drive the selected one of the plurality of known seat and leg support position actuators in accordance with the parameter data.

In accordance with another aspect of the present invention, an actuator controller for closed-loop controlling one of a seat and leg support position actuator of a wheelchair comprises: a digital controller coupleable to a communication bus of the wheelchair and operative to receive a desired actuator position signal from the communication bus; an actuator driver circuit coupled to the digital controller and responsive to control signals from the digital controller to drive the position actuator; and a position sensor circuit for receiving an actuator position signal from a position sensor of the position actuator, the digital controller operative to read the actuator position signal from the position sensor circuit, the digital controller operative to perform a closed-loop control of the position actuator using the actuator driver circuit based on the desired and read actuator position signals.

In accordance with yet another aspect of the present invention, a wheelchair control system comprises: a system controller; a communication bus; a plurality of actuator controllers, the system controller and the plurality of actuator controllers coupled to the communication bus for transmitting and receiving signals thereover, each actuator controller of the plurality for closed-loop controlling a corresponding one of a plurality of position actuators of the wheelchair, each actuator controller comprising: a digital controller coupleable to the communication bus and operative to receive a desired actuator position signal transmitted by the system controller over the communication bus; an actuator driver circuit coupled to the digital controller and responsive to control signals from the digital controller to drive the corresponding position actuator; and a position sensor circuit for receiving an actuator position signal from a position sensor of the corresponding position actuator, the digital controller operative to read the actuator position signal from the position sensor circuit, the digital controller operative to perform a closed-loop control of the corresponding position actuator using the actuator driver circuit based on the desired and read actuator position signals of the position actuators.

### BRIEF DESCRIPTION OF THE DRAWINGS

FIG. 1 is a block diagram schematic of a wheelchair control system suitable for embodying one or more aspects of applicants' general concept.

FIG. 2 is a block diagram schematic of an exemplary embodiment of a single actuator controller.

FIG. 3 is a block diagram schematic of an exemplary embodiment of a dual actuator controller.

FIG. 4 is a top view perspective of an exemplary printed circuit board for containing the components of a single actuator controller.

FIG. 5 is a top view perspective of an exemplary printed circuit board for containing the components of a dual actuator controller.

FIG. 6 depicts an exemplary look-up table for use in programming the actuator controller.

### DETAILED DESCRIPTION

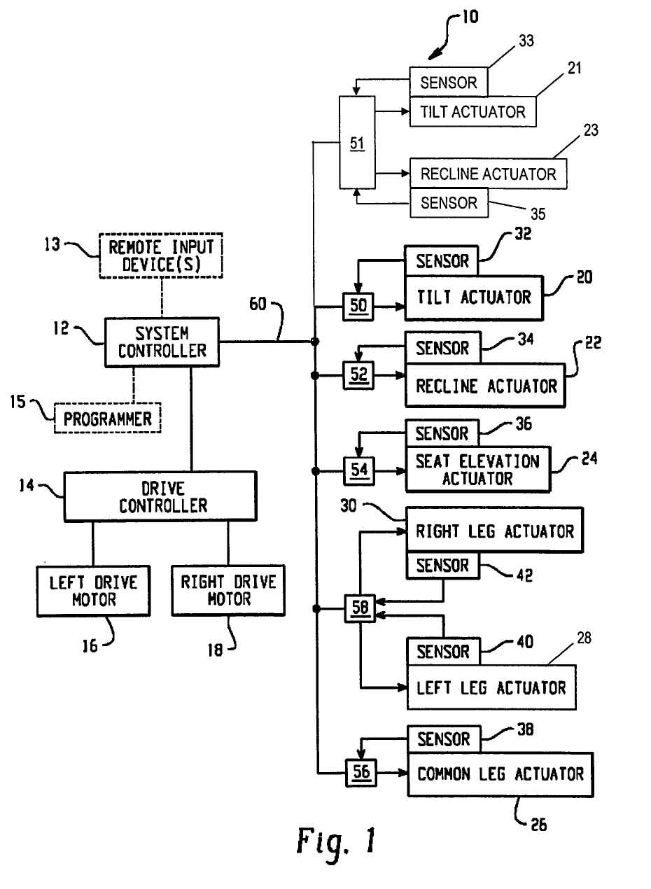

FIG. 1 is a block diagram schematic of a wheelchair control system 10 suitable for embodying one or more aspects of applicants' general concept. Referring to FIG. 1, the control system 10 comprises a system controller 12 which is coupled to a drive controller 14 for directing movement of the wheelchair. The system controller 12 may be embodied in a multi-purpose joystick unit with an integral display, or a display unit with input pushbuttons and/or switches for interacting with the display, for example. The drive controller 14 is operative to cause movement of the wheelchair according to the directions it receives from the control system 12 by providing appropriate drive signals to left and right wheel drive motors, 16 and 18, respectively, which are mechanically coupled to the respective left and right wheels of the wheelchair. Remote input devices 13, like a joystick unit, for example, may also be coupled to the system controller 12 to provide user input for control of the wheelchair. In addition, a programmer unit 15 may also be coupled to the system controller, at times, for programming various operational parameters and settings into a memory thereof.

In the present embodiment, a wheelchair power seat arrangement may include a tilt actuator 20, a recline actuator 22 and a seat elevation actuator 24 which are mechanically coupled to their respective seat portions and electrically driven individually to power position the seat according to desired seat position settings. In addition, a power leg support arrangement may include a common leg actuator 26 which is mechanically coupled to a common leg support for both left and right legs of the user and electrically driven to power position the leg support according to a desired position setting. In some wheelchair models, the user may desire individual left and right leg support position control. In these models, individual left and right leg actuators 28 and 30, respectively, are mechanically coupled to respective left and right leg supports. Each left and right leg actuator 28 and 30 is electrically driven individually to power position the respective leg support according to its desired position setting. In one configuration, the individual left and right leg actuators may be set up to be controlled in unison such that the two leg actuators provide the same response as the common leg actuator. In another embodiment, a tilt actuator 21 and a recline actuator 23 may be independently controlled, yet paired together via a dual controller.

In addition, a position sensor may be disposed at each of the aforementioned actuators. The position sensor may or may not be integral to the actuator. The position sensors of the actuators may be of different types to accommodate the application of the actuator. The different types of position sensors may include a potentiometer for yielding a voltage based on the instantaneous actuator position, a reed switch for providing pulses of actuator movement, each pulse representing a predetermined incremental movement, and an encoder for providing an analog or digital signal representative of the instantaneous actuator position, for example.

In the present embodiment, the tilt actuators 20, 21 with its integral position sensor 32, 33 may be of the type manufactured by LINAK under the part number 301074-01; the recline actuators 22, 23 with its integral position sensor 34, 35 may be of the type manufactured by LINAK under the part number LA31-U139-03; the seat elevation actuator 24 with its position sensor 36 may be of the type manufactured by Motion Controls under the model number 85972-001; the common leg actuator 26 with its integral position sensor 38 may be of the type manufactured by LINAK under the part number 301088-03; and the left and right leg actuators 28 and 30 with their respective position sensors 40 and 42 may be of the type manufactured by SKF Motion Technologies, for example. However, it is understood that other types of position actuators with position sensors which may or may not be integral to the actuator may be used just as well without deviating from the broad principles of applicants' general concept.

Also in the present embodiment, certain actuators 20, 22, 24, and 26 may include a single actuator controller 50, 52, 54, and 56, respectively, for individually and independently controlling the position of its respective actuator based on a desired position set point or setting. In each case, the actuator controllers 50, 52, 54, and 56 may operate as closed-loop controllers using the signal output of their respective position sensor 32, 34, 36, and 38 as a feedback signal. Each actuator controller 50, 52, 54, and 56 may be integral to its respective actuator 20, 22, 24, and 26, but this need not be the case. The actuators 28 and 30, if used, may include a dual actuator controller 58 for individually and independently closed-loop controlling the positions of the actuators based on the desired position setting of each. The signal outputs of the respective position sensors 40 and 42 provide the position feedback signals for the closed-loop control. The controller 58 may be integral to one or the other of the actuators 28 and 30, but this also need not be the case. Similarly, the actuators 21 and 23, if used, may include a dual actuator controller 51 for individually and independently closed-loop controlling the positions of the actuators based on the desired position setting of each. The signal outputs of the respective position sensors 33 and 35 provide the position feedback signals for the closed-loop control. The controller 51 may be integral to one or the other of the actuators 21 and 23, but this also need not be the case.

In the present embodiment, all of the controllers 50 - 58 may be coupled to the system controller 12 over a system bus 60 which may be a CAN bus, for example. Accordingly, each of the controllers 50-58 as well as the system controller 12 will include a CAN bus interface to accommodate bidirectional communication therebetween over the bus 60 in accordance with an established CAN bus protocol. In this arrangement, the system controller 12 may transmit individual position settings and/or commands to the actuator controllers 50-58 over the system bus 60. Each individual controller 50-58 will drive its corresponding actuator to the desired position setting, preferably in a closed-loop manner, using the respective position sensor signal as the position feedback. In this arrangement, the system controller 12 may provide the desired seat and leg support position settings to the actuator controllers 50-58 over the system bus 60 and the individual actuator controllers may perform their closed-loop control autonomously. The controllers 50-58 are also operative to transmit the actual positions of their respective actuators over the system bus 60 back to the system controller 12 for use and storage therein.

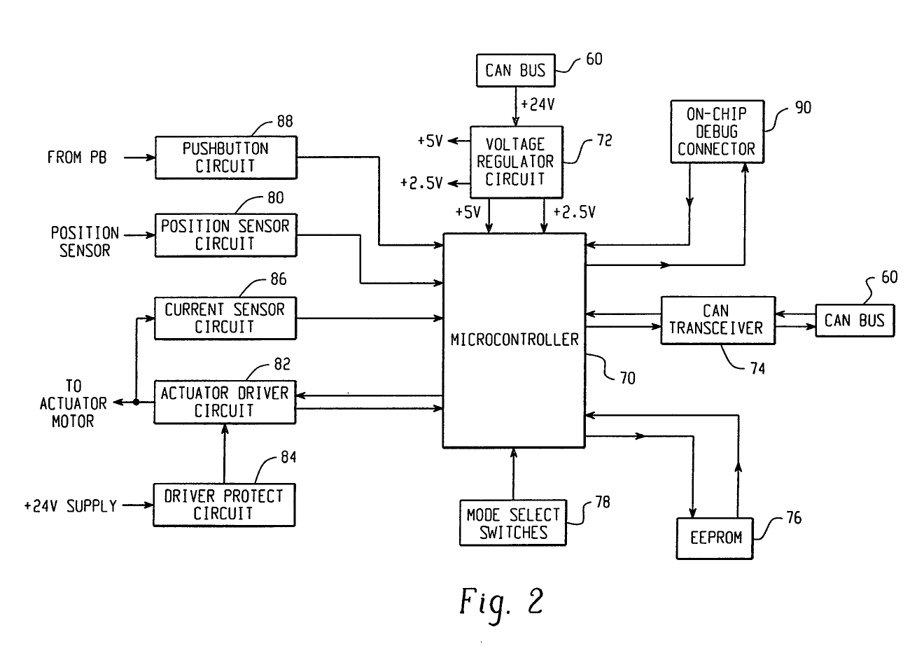

A common single actuator controller embodiment suitable for use as any one of the controllers 50, 52, 54, 56 and programmable to the characteristics of the actuator it is controlling is shown, by way of example, in the block diagram schematic of FIG. 2. Referring to FIG. 2, central to the common controller is a microcontroller circuit 70 which may be an integrated circuit of the type manufactured by Infineon Technologies under the model number SAF-XC164CM, for example. The microcontroller integrated circuit 70 may include: a microprocessor unit; memory, both volatile and non-volatile; digital input and output ports; an analog-to-digital (A/D) converter; and one or more CAN bus controllers, for example. The microcontroller 70 executes instructions of various programs to perform both calibration and normal operations of the actuator controller.

In the present embodiment, a +24V switched power signal is provided, preferably over the CAN bus 60, and coupled to a voltage regulator circuit 72 which produces both +5 VDC and +2.5 VDC regulated power sources therefrom. The regulator 72 may be a switched mode voltage regulator with thermal protection. The regulated +5V and 2.5V power sources are used to power the microcontroller circuit 70 and other circuits of the actuator controller. However, it is understood that other possible voltages may be employed for powering the actuator controller depending on the circuits included therein.

A CAN bus transceiver circuit 74 couples one of the CAN controllers of the microcontroller 70 to the CAN bus 60 for transmitting signals over and receiving signals from the CAN bus 60 in accordance with the established CAN bus protocol. In the present embodiment, the transceiver circuit 74 permits the microcontroller 70 to receive actuator position settings and/or commands from the system controller 12 and transmit status data to the system controller 12, including the current actuator position. A non-volatile memory 76, like a 32K byte electrically erasable programmable read only memory or EEPROM, for example, may be disposed external to the microcontroller 70 and coupled thereto for non-volatile storage of the operational programming for the microcontroller 70 and certain data including actuator position and position settings, actuator position limits, and possibly, parameter settings for different modes, for example.

A set of mode select switches 78, which may include four settable switches in a DIP package, for example, may be also coupled to digital input ports of the microcontroller 70 for manually setting a digital code representative of an operating mode of the controller. For example, the code of the switches 78 may identify the actuator model to which the controller is connected including the type of position sensor of the actuator. The mode setting of switches 78 may be read into the microcontroller 70 for use by the microcontroller 70 to select the operating parameters associated with the actuator and position sensor to which the controller is connected. In this manner, the common single actuator controller may be programmed for use with any one of a known plurality of power seat and leg support position actuators. In the alternative, the coding of the operational mode designated for the single actuator controller may be supplied by the system controller 12 over the CAN bus 60 to the microcontroller 70 via transceiver 74. Additionally, the switch settings or code may be used to set the actuator controller in a calibration mode as will become more evident from the description supra.

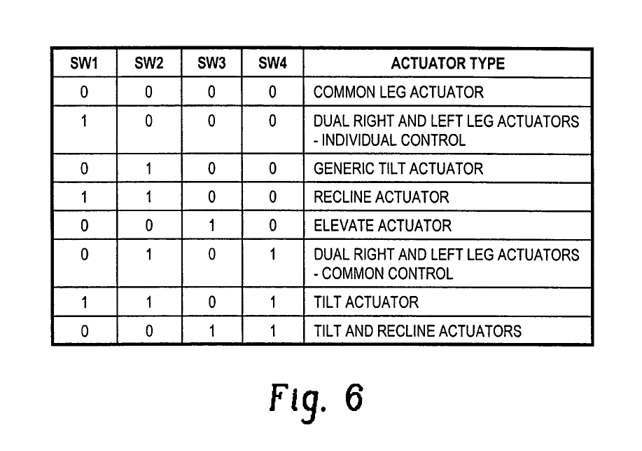

The microcontroller 70 may include a look-up table for decoding the four bit codes set by the switches 78. An exemplary look-up table for this purpose is shown in the table of FIG. 6. Referring to the table of FIG. 6, the status of the switches 78, e.g. 0 for “off” and 1 for “on”, are depicted in the four columns labeled SW1, SW2, SW3 and SW4 and the corresponding mode is depicted in the column labeled “Mode”. Thus, in the present embodiment, if the microcontroller 70 reads in the switch status or code 0, 0, 0, 0 from the switches SW1, SW2, SW3, and SW4, respectively, then, it will setup the parameters for normal operation of the common leg actuator and position sensor corresponding thereto in accordance with the look-up table. The switches SW1, SW2, SW3 and SW4 may be set to a different status or code for calibration of the common leg actuator, then instead of setting up the parameters for normal operation of the common leg actuator, the microcontroller 70 will setup a calibration routine for the common leg actuator as will become better understood from the description found herein below. The microcontroller 70 will perform the same switch code decoding operations for the other actuators of the present embodiment in accordance with the look-up table of FIG. 6.

The feedback position signal from the associated position sensor may be input to the actuator controller through a signal conditioning circuit 80 which is connected to the microcontroller 70 through either an A/D converter input or one or more digital inputs thereof, dependent on whether the conditioned position signal is analog or digital. In the present embodiment, the conditioning circuit 80 may accommodate the signal output of any one of a potentiometer, reed switch, encoder sensor, mercury switch, magnetic switch, microswitch, or any other suitable sensor, but it is understood that individual conditioning circuits for each sensor may be used just as well. In addition, while certain position sensors have been described for use with the present embodiment, it is further understood that applicants' general concept is not limited to any specific position sensor, but rather any suitable sensor may be used for measuring actuator position. In the present embodiment, the microcontroller 70 may read in the instantaneous actuator position from the sensor input signal during normal operations every approximately two milliseconds for use thereby as will become more evident from the description below.

The microcontroller 70 drives the electrical actuator motor through an actuator driver circuit 82 which may comprise an integrated circuit, manufactured under model no. A3940, for example, which accommodates digital control signals from the microcontroller 70 to set motor direction and operational control of the circuit 82. In driving the actuator via circuit 82, the microcontroller 70 uses the pre-programmed operational parameters identified by the mode setting of switches 78 (see table of FIG. 6). The driver circuit 82 applies power to the actuator motor which it receives from a power source, which may be a +24V battery or batteries, for example.

The driver circuit 82 may also supply status feedback signals to the microcontroller 70 indicative of whether or not the driver circuit is operating properly. These status signals may be continuously monitored by the microcontroller 70, every cycle, for example, and if appropriate, the microcontroller drive to the actuator may be withdrawn, thus, stopping movement of the actuator.

A driver protection circuit 84, which may comprise a p-channel transistor circuit, manufactured under model no. IRFR5305, for example, or a diode circuit, manufactured under model no. 48CTQ0605, for example, may be coupled between the power source and driver circuit 82 for protecting the actuator driver circuit 82 from mishaps, such as reverse power source voltage misconnection, overvoltage, voltage spikes and the like.

In addition, a current sense circuit 86, which may comprise an Allegro integrated circuit manufactured under model no. ASC704-15, for example, may be coupled to an output line of the actuator driver circuit 82 to sense the drive current supplied to the actuator motor. A signal representative of the sensed motor current may be supplied from circuit 86 to an A/D converter port of the microcontroller 70 for use thereby. For example, the microcontroller 70 may monitor the current sense signal for a dramatic rise in motor current which may be indicative of an actuator that is stuck or limited by an end of travel stop. If this is detected by the microcontroller 70, the drive signal to the actuator drive circuit 82 may be set to zero to protect the actuator motor.

In addition to the autonomous closed-loop control function, the controller 70 may further accommodate manual control through a pushbutton switch, for example. Manual control may be used when the controller 70 is set in a calibration mode, for example, for positioning the seat and/or leg support portions. In any event, a switch may be connected to a condition circuit 88 which monitors the status of the contacts and supplies a signal to the microcontroller 70 representative thereof. Still further, certain signals may be provided from the microcontroller 70 to a connector 90 of the controller for debugging purposes. Accordingly, a direct connection may be made between the microcontroller 70 and another computer, for example, via connector 90 for development and debug monitoring purposes.

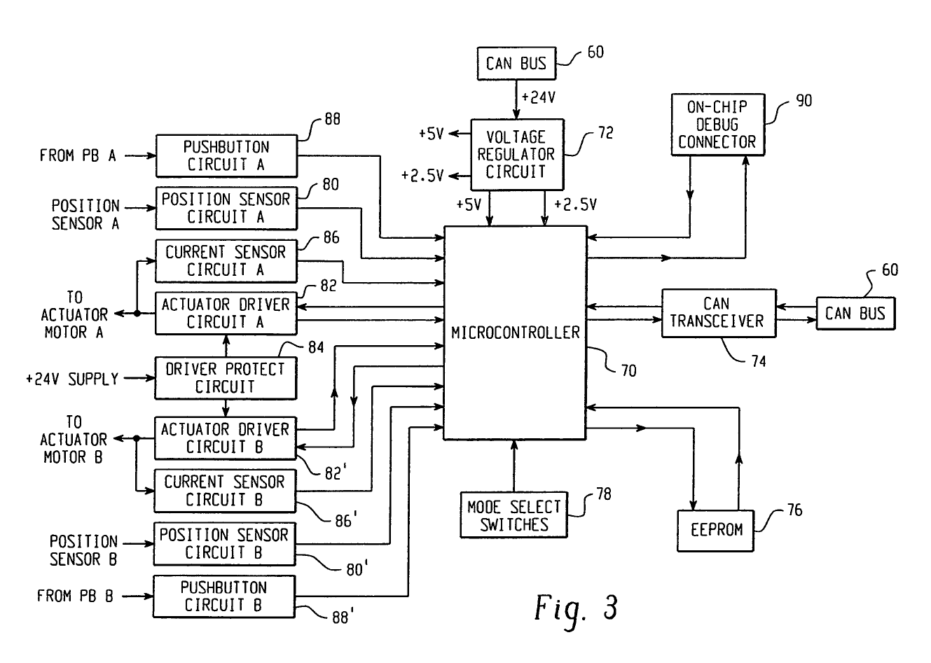

A dual actuator controller embodiment suitable for use as the controller 51, 58 and programmable to the characteristics of the two actuators it is controlling is shown, by way of example, in the block diagram schematic of FIG. 3. Referring to FIG. 3, all of the circuits described in connection with the single actuator controller embodiment of FIG. 2 may be included in the dual actuator controller and will maintain the same reference numerals as used in the description of FIG. 2. Since the function of these circuits remain the same or similar to the circuits of the single actuator controller, no further description thereof is provided. The circuits 70, 72, 74, 76, and 90 will be common to both actuator controllers. The switches 78 may have more than four switches, maybe eight switches, for example, to include sufficient input coding for both actuators being controlled by the microcontroller 70. FIG. 6, for example, shows how four mode select switches 78 might be configured for independently-controlled dual right and left actuators 28, 30 (i.e., SW1=1, SW2=0, SW3=0, SW4=0), dual right and left actuators 28, 30 that operate in unison (i.e., SW1=0, SW2=1, SW3=0, SW4=1), and independently-controlled dual tilt and recline actuators 21, 23 (i.e., SW1=0, SW2=0, SW3=1, SW4=1).

The position sensor circuit 80, actuator driver circuit 82, current sensor circuit 86, and pushbutton circuit 88 will provide control of one of the two actuators, designated as the A actuator. Also included in the dual actuator controller are duplicate circuits of circuits 80, 82, 86 and 88 which will be labeled as 80′, 82′, 86′ and 88′, respectively. The position sensor circuit 80′, actuator driver circuit 82′, current sensor circuit 86′, and pushbutton circuit 88′ will provide control of the other of the two actuators, designated as the B actuator. The driver protection circuit 84 will provide common protection to both or the actuator driver circuits 82 and 82′. In the present embodiment, the A actuator may be the left leg actuator 28 or the tilt actuator 21 and the B actuator may be the right leg actuator 30 or the recline actuator 23 as shown in FIG. 1.

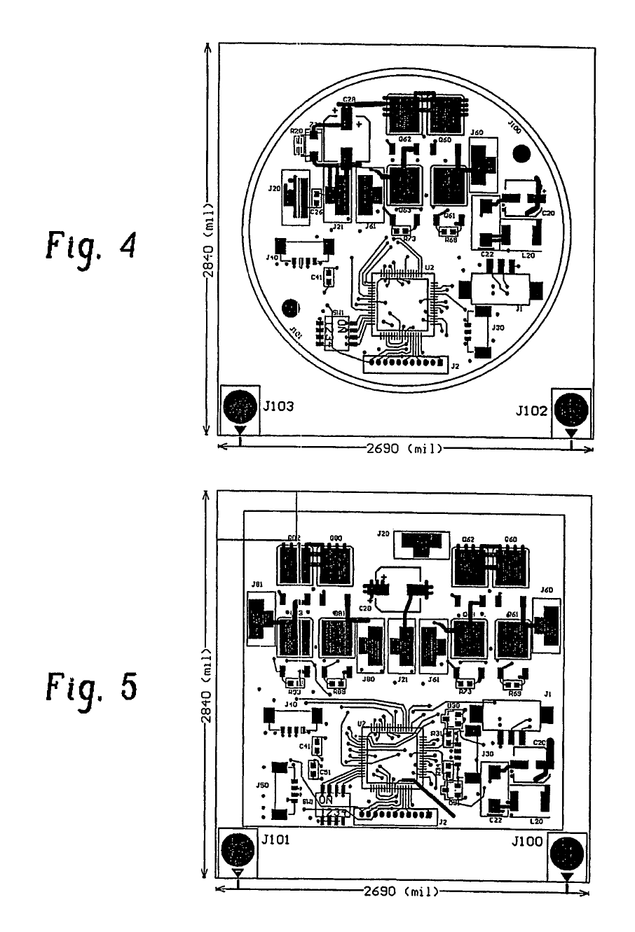

As noted above the single actuator controller embodiment of FIG. 2 may be made integral to the actuator it is controlling, preferably housed within a compartment of the actuator, for example. To achieve this implementation, all of the electronic components of the controller may be disposed on a printed circuit board (PCB) of the size to fit within a housed compartment of a power seat or leg support actuator. A top view of an exemplary PCB suitable for containing the components of the single actuator controller is shown in FIG. 4. Referring to FIG. 4, the PCB, which may be a four level board, for example, is sized and shaped on its sides to fit in a small compartment of the actuator. For example, the PCB for a single actuator may measure approximately 2690 mils by approximately 2840 mils.

The dual actuator controller embodiment of FIG. 3 may be also implemented on a PCB, such as the PCB shown in top view, by way of example, in FIG. 5, for the purposes of integrating the dual actuator controller into a housed compartment of one of the actuators it is controlling. Note that the PCB of the dual actuator controller, for example, may have more surface area real estate than the single actuator controller PCB of FIG. 4 to include the duplicated circuits for the second actuator that it may control. However, as shown in FIG. 5, the outside dimensions of the PCB for the dual actuator controller may be the same as the single actuator controller PCB of FIG. 4. The dual controller PCB may be also a four level PCB.

Referring back to FIG. 2, when the mode switches 78 are set for the normal operation as exemplified in the table of FIG. 6, a couple of operations may be performed by the microcontroller 70. First, a manual or local operation may be performed utilizing the manual PB, which may be a momentary switch, for example. When the manual PB is depressed and held, the microcontroller 70 senses the state thereof via the signal supplied from the circuit 88 and responds by driving the actuator motor through the actuator driver circuit 82 to extend the actuator in one direction. When the switch is released, the drive to the actuator motor will cease causing the actuator extension to stop. If the manual PB is depressed again within about one second of release, the actuator motor will continue to be driven in the same direction. If the button is depressed again beyond the one second time period from release, the controller 70 senses the time elapsed and responds by driving the actuator motor through the actuator driver circuit 82 to extend the movement of the actuator in a direction opposite the one direction. The actuator will continue to be driven in the opposite direction so long as the manual PB is depressed.

Second, when the switches 78 are set for normal operation as exemplified in the table of FIG. 6, the controller 70 may respond to position set points and/or commands from the system controller 12 via the CAN bus 60. When responding to position set points, the controller 70 may perform closed-loop control of the actuator using the position sensor signal from circuit 80 as a feedback signal. In this state, the microcontroller 70 will drive the actuator motor via the drive circuit 82 in direction and speed according to an error signal between the position set point and feedback position sensor signal based on a predetermined control strategy, which may be proportional only, for example. In the present embodiment, the microcontroller 70 is operative to drive the actuator motor via the drive circuit 82 with a pulse width modulating signal at the beginning and end of movement thereof so as to provide a smooth acceleration and deceleration of actuator movement. When the feedback position sensor signal reaches the position set point, the microcontroller 70 will cease driving the actuator motor which will stop the actuator at the position of the set point.

When responding to commands, the controller 70 may perform the command and respond to the system controller 12 accordingly. Some exemplary commands which may be received by the actuator controller from the system controller 12 via the CAN bus include: a wake up command, a mode change command, a heart beat command, a calibrate mode command, an actuator drive command, and an actuator position request command. The wake up command along with a certification/authentication code or number may be sent to each actuator controller which may respond accordingly by sending back to the system controller 12 via the CAN bus an authentication value. This process of wake up and response from each actuator controller identifies all qualified actuator controllers on the wheelchair. The mode change command may be sent to an actuator controller to instruct such controller to change to one of the modes of start up, operating, shutdown and power down, for example. This command may be used in the present embodiment to synchronize operational changes of an actuator of the wheelchair from start up through power down. The heartbeat command may include a time period for each actuator controller to send a heart beat response, e.g., 100 milliseconds. The heart beat commands may be periodically sent by each device on the CAN bus, including the system controller 12, to ensure proper wheelchair operation.

The calibrate mode command may be sent to an actuator controller to instruct such controller to perform one of the following operations: enter, capture retract position, capture extended position, and exit, for example. The actuator drive command may be sent to an actuator controller to instruct the actuator controller to drive the associated actuator motor in a specific direction and specified speed in the command. The actuator position request command may be sent to the actuator controller to retrieve the position of the associated actuator. Upon receipt of the command, the actuator controller transmits the current actuator position back to the system controller 12 via the CAN bus. The actuator controller may also transmit the current actuator position back to the system controller 12 without a command to do so when the actuator motor changes position and/or changes status.

In the calibration mode, the execution of a calibration routine may be started by the microcontroller 70 in response to either the depression of the manual PB or the calibration command issued by the system controller 12 via the CAN bus 60, for example. One of the tasks performed by the execution of the calibration routine is to setup the software travel limits of the actuator. For this task, the microcontroller 70 drives the actuator motor to retract the actuator until the microcontroller 70 senses that the actuator has stopped moving using the position sensor signal, for example. In this state, the microcontroller 70 may read in and store the position sensor signal as the fully retracted position of the actuator. Then, the microcontroller 70 drives the actuator motor to extend the actuator until the microcontroller 70 senses that the actuator has stopped moving using the position sensor signal, for example. In this state, the microcontroller 70 may read in and store the position sensor signal as the fully extended position of the actuator. The software travel limits may then be calculated using the fully retracted and extended positions and stored in the EEPROM 76.

Thus, once calibration is completed, the actuator controller may be powered down. Then, when powered back up, the microcontroller 70 may go through an initialization routine including the steps of: reading into local memory the software travel limits from the EEPROM 76; reading in the status or code of the switches 78 for identifying the actuator it is controlling, as defined in the look-up table of FIG. 6, for example, setting up the parameters therefor; and setting up the CAN message identifiers for communicating with the system controller 12 via the CAN bus 60. Once initialized, the microcontroller 70 may execute the normal operation routines for controlling the corresponding actuator according to the desired set point and/or commands communicated thereto from the system controller 12 via the CAN bus transceiver 74 and CAN bus 60. During normal operation, the microcontroller 70 may monitor the status of the manual PB and respond accordingly, if a depression of the PB is detected.

Also during normal or manual operation, the monitored status and actuator position signals will be monitored by and read into the microcontroller 70 as noted above. Periodically or otherwise, status and actuator position data may be transmitted by the microcontroller 70, using the CAN controller thereof, to the system controller 12 via the CAN bus transceiver 74 and CAN bus 60 following the conventional CAN bus protocol.

The dual actuator controller embodiment of FIG. 3 will operate the same as the single actuator controller of FIG. 2 as described herein above, except that the microcontroller 70 thereof will execute calibration and normal operation routines for both of the actuators A and B.

While the present invention has been described herein above in connection with one or more embodiments, it is understood that such embodiments were presented herein merely by way of example. Thus, the present invention should not be limited in any way by the described embodiments, but, rather construed in breadth and broad scope in accordance with the recitation of the claims appended hereto.

What is claimed is:

1. Actuator controller for operating a selected one of a plurality of known seat and leg support position actuators of a wheelchair, said actuator controller comprising:
a digital controller; and
an actuator driver circuit coupled to said digital controller and capable of driving any one of said plurality of known seat and leg support position actuators, said digital controller programmable with data representative of a selected one of said plurality of known seat and leg support position actuators and operational parameters thereof, and operative to control said actuator driver circuit to drive said selected one of said plurality of known seat and leg support position actuators in accordance with said parameter data.

2. The actuator controller of claim 1 wherein the digital controller is operative to receive the data representative of the selected one of said plurality of known seat and leg support position actuators and the operational parameters thereof communicated thereto.

3. The actuator controller of claim 1 including a memory for storing operational parameters of each of said plurality of known seat and leg support position actuators, said stored operational parameters of said memory accessible by said digital controller.

4. The actuator controller of claim 3 including a selector for communicating the data of the selected one of the plurality of known seat and leg support position actuators to the digital controller which is operative to respond to the selection data by controlling the actuator driver circuit to drive the selected position actuator in accordance with the operational parameters thereof accessed from the memory.

5. The actuator controller of claim 4 wherein the selector is programmable with a code representative of the selected one of the plurality of known seat and leg support position actuators; and wherein the digital controller is operative to read said code from the selector and, based on said code, to access the operational parameters of the selected position actuator from the memory for use in controlling the actuator driver circuit.

6. The actuator controller of claim 5 wherein the selector comprises a set of switches coupled to digital inputs of the digital controller for providing a digital code thereto; and wherein the digital controller is operative to read the code provided by the set of switches.

7. The actuator controller of claim 1 including: a position sensor circuit coupled to the digital controller and capable of receiving signals from any one of a plurality of known actuator position sensors and generating a signal representative of the received sensor signal which is readable by the digital controller; and a selector operative to communicate data of a selected one of said plurality of actuator position sensors to said digital controller which is operative to respond to said selection data to render actuator position data from said signal read from the position sensor circuit.

8. Actuator controller for closed-loop controlling one of a seat and leg support position actuator of a wheelchair, said actuator controller comprising:
a digital controller coupleable to a communication bus of said wheelchair and operative to receive a desired actuator position signal from said communication bus;
an actuator driver circuit coupled to said digital controller and responsive to control signals from said digital controller to drive said position actuator; and
a position sensor circuit for receiving an actuator position signal from a position sensor of said position actuator, said digital controller operative to read said actuator position signal from the position sensor circuit,
said digital controller operative to perform a closed-loop control of said position actuator using said actuator driver circuit based on said desired and read actuator position signals.

9. The actuator controller of claim 8 wherein the wheelchair communication bus comprises a CAN bus.

10. The actuator controller of claim 8 wherein the digital controller is operative in a selected one of a normal mode and a calibration mode in controlling the position actuator.

11. The actuator controller of claim 8 including a current sense circuit monitored by the digital controller for determining an operational status of the position actuator.

12. The actuator controller of claim 8 including a driver protection circuit monitored by the digital controller for protecting the actuator driver circuit against mishaps.

13. The actuator controller of claim 8 including:
a second actuator driver circuit coupled to said digital controller and responsive to control signals from said digital controller to drive a second position actuator; and
a second position sensor circuit for receiving an actuator position signal from a second position sensor of said second position actuator, said digital controller operative to read said actuator position signal from the second position sensor circuit,
said digital controller operative to receive a desired second actuator position signal for the second position actuator from said communication bus, and operative to perform a closed-loop control of both of the position actuator using said actuator driver circuit based on said desired and read actuator position signals and said second position actuator using said second actuator driver circuit based on said desired and read second actuator position signals.

14. The actuator controller of claim 8 wherein the digital controller is operative to transmit the read actuator position signal over the communication bus.

15. The actuator controller of claim 8 wherein the digital controller is operative to respond to commands received from the communication bus.

16. Wheelchair control system comprising:
a system controller;
a communication bus;
a plurality of actuator controllers, said system controller and said plurality of actuator controllers coupled to said communication bus for transmitting and receiving signals thereover, each actuator controller of said plurality for closed-loop controlling a corresponding one of a plurality of position actuators of the wheelchair, each said actuator controller comprising:
a digital controller coupleable to said communication bus and operative to receive a desired actuator position signal transmitted by said system controller over said communication bus;
an actuator driver circuit coupled to said digital controller and responsive to control signals from said digital controller to drive said corresponding position actuator; and
a position sensor circuit for receiving an actuator position signal from a position sensor of said corresponding position actuator, said digital controller operative to read said actuator position signal from the position sensor circuit,
said digital controller operative to perform a closed-loop control of said corresponding position actuator using said actuator driver circuit based on said desired and read actuator position signals of said position actuators.

17. The control system of claim 16 wherein the digital controller of each actuator controller is operative to transmit the corresponding read actuator position signal over the communication bus to the system controller.

18. The control system of claim 16 wherein the digital controller of each actuator controller is operative to respond to commands received from the system controller over the communication bus.

19. The control system of claim 18 wherein the digital controller of each actuator controller is operative to transmit the corresponding read actuator position signal over the communication bus to the system controller in response to a command received from the system controller.

20. The control system of claim 16 wherein at least one actuator controller of said plurality is disposed at the position actuator corresponding thereto.
